(19) United States
(12) Patent Application Publication
(10) Pub. No.: US 2025/0285294 A1
(43) Pub. Date: Sep. 11, 2025

(54) METHOD AND APPARATUS FOR TRACKING

(71) Applicants: Hyundai Motor Company, Seoul (KR); Kia Corporation, Seoul (KR)

(72) Inventor: Ji Hee Han, Hwaseong-Si (KR)

(21) Appl. No.: 18/918,433

(22) Filed: Oct. 17, 2024

(30) Foreign Application Priority Data
Mar. 7, 2024 (KR) 10-2024-0032776

(51) Int. Cl. G06T 7/246; G06V 10/44; G06V 10/764

(52) U.S. Cl. CPC G06T 7/246; G06V 10/44; G06V 10/764; G06T 2207/20081; G06V 2201/07

(57) ABSTRACT

A tracking method according to an example of the present disclosure may include generating, by a generation device, a first feature based on a first frame through a backbone, generating, by the generation device, first detection information indicating a detection result for a first object based on the first feature through a first neck for object detection, generating, by the generation device, a first feature vector for a visual feature of the first object based on the first feature through a second neck for object re-identification, and/or performing, by a tracking device, tracking based on the first detection information and the first feature vector.

### CROSS-REFERENCE TO RELATED APPLICATIONS

The present application claims priority to Korean Patent Application No. 10-2024-0032776, filed Mar. 7, 2024, the entire contents of which are incorporated herein by reference for all purposes.

### TECHNICAL FIELD

The present disclosure relates to object detection, and more specifically, relates to a method for tracking and an apparatus thereof.

### BACKGROUND

With the development of a deep neural network-based computer vision technology in an autonomous driving technology, various artificial intelligence models such as object detection, semantic segmentation, depth map estimation, and lane detection are being studied. Research is continuing on a method for performing autonomous driving by tracking objects by using artificial intelligence models. For example, a model for object detection and a model for object re-identification may be used for tracking. A method capable of improving the performance speed of an algorithm without deteriorating the performance of object detection with regard to tracking may be needed.

### SUMMARY

The present disclosure may solve the above-mentioned problems occurring in the prior art while advantages achieved by the prior art are maintained intact.

An aspect of the present disclosure may provide a method and an apparatus device that improve tracking performance without causing performance degradation in object detection.

An aspect of the present disclosure may provide a method and an apparatus device that perform training on an object re-identification model by applying a knowledge distillation technique.

An aspect of the present disclosure may provide a method and an apparatus device that perform training on an object re-identification model by using a pre-trained model.

An aspect of the present disclosure may provide a method and an apparatus device that simultaneously performs object detection and object re-identification.

An aspect of the present disclosure may provide a method and an apparatus device that perform multi-task learning associated with tracking.

The technical problems to be solved by the present disclosure are not limited to the aforementioned problems, and any other technical problems not mentioned herein will be clearly understood from the following description by those skilled in the art to which the present disclosure pertains.

An apparatus may comprise: a memory configured to store computer-executable instructions; and at least one processor configured to execute the computer-executable instructions by accessing the memory, wherein the at least one processor is configured to: generate, based on a first frame and via a backbone of a detection model, a first feature, generate, based on the first feature and via a first neck of the detection model, first detection information indicating a detection result for a first object, wherein the first neck is configured for object detection, generate, based on the first feature and via a second neck of the detection model, a first feature vector for a visual feature of the first object, wherein the second neck is configured for object re-identification; and perform, based on the first detection information and the first feature vector, tracking of at least one object comprising the first object.

The at least one processor may be configured to: train, based on a first model pre-trained on the object re-identification, a second model, wherein the second model comprises the backbone, the first neck, and the second neck.

The at least one processor may be configured to: train the second neck in a state where parameters of the backbone and the first neck are fixed.

The at least one processor may be configured to: generate, based on a first input image and via the first model, a second feature vector; generate, based on a second input image and via the backbone and the second neck, a third feature vector; generate, based on the second feature vector and the third feature vector, a first loss; and train, based on the first loss, the second neck.

The at least one processor may be configured to: generate, based on the third feature vector and ground truth (GT), a second loss; and train the second neck based on the first loss and the second loss.

The at least one processor may be configured to: generate, based on the third feature vector and via a classification network, a classification vector, and generate the second loss by comparing the classification vector and the GT.

The GT may comprise hard labeled data.

The second feature vector may comprise soft labeled data.

The first input image may be an image obtained by extracting an object area from the second input image.

The at least one processor may be configured to: generate a first association vector obtained by combining the first detection information and the first feature vector; generate, based on a second frame and via the backbone, a second feature, wherein the second frame is a next frame of the first frame; generate, based on the second feature and via the first neck, pieces of second detection information about a plurality of second objects; generate, based on the second feature and via the second neck, fourth feature vectors for visual features of the plurality of second objects; generate second association vectors, wherein the second association vectors are obtained by respectively combining the pieces of second detection information and the fourth feature vectors; and perform the tracking by associating the first object with an object having an association vector, among the second association vectors, that is closest to the first association vector.

One or more methods may be performed by at least one computing device to perform one or more operations described herein and/or to implement one or more features described herein.

The features briefly summarized above with respect to the present disclosure are merely aspects of the detailed description of the present disclosure described below, and do not limit the scope of the present disclosure.

### BRIEF DESCRIPTION OF THE DRAWINGS

The above and other objects, features and advantages of the present disclosure may be more apparent from the following detailed description taken in conjunction with the accompanying drawings:

FIG. 1 shows an example of a diagram showing a tracking method, according to an example of the present disclosure;

FIG. 2 shows an example of a flowchart showing a tracking method, according to an example of the present disclosure;

FIG. 3 shows an example of a diagram showing a tracking method, according to an example of the present disclosure;

FIG. 4 shows an example of a diagram showing a tracking method, according to an example of the present disclosure;

FIG. 5 shows an example of a flowchart showing a tracking method, according to an example of the present disclosure;

FIG. 6 shows an example of a diagram showing a tracking method, according to an example of the present disclosure;

FIG. 7 shows an example of a flowchart showing a tracking method, according to an example of the present disclosure;

FIG. 8 shows an example of a diagram showing a tracking method, according to an example of the present disclosure;

FIG. 9 shows an example of a block diagram of a tracking apparatus, according to an example of the present disclosure; and

FIG. 10 shows an example of a block diagram of a computing system for executing a tracking method, according to an example of the present disclosure.

### DETAILED DESCRIPTION

Hereinafter, various examples of the present disclosure may be described in detail with reference to the accompanying drawings, so that those skilled in the art may easily carry out the present disclosure. However, the present disclosure may be embodied in many different forms and may not be construed as limited to the examples set forth herein.

In describing the examples of the present disclosure, if a specific description of the related art is deemed to obscure the subject matter of the examples of the present disclosure, the detailed description will be omitted. In addition, in the drawings, parts that are not related to the description of the present disclosure are omitted, and similar parts are given similar reference numerals.

In the present disclosure, it will be understood that if an element is referred to as being “connected” or “coupled” to another element, it may be directly connected or indirectly connected to another element. In addition, if some part ‘includes’ or “possess” some elements, unless explicitly described to the contrary, it means that other elements may be further included but not excluded.

In the present disclosure, expressions such as “first,” or “second,” and the like, may express their elements regardless of their priority or importance and may be used to distinguish one element from another element but is not limited to these components. For example, without departing from the scope of the present disclosure, a first component of one example may be referred to as a second component of another example. Similarly, a second component of one example may be referred to as a first component of another example.

In the present disclosure, components that are distinguished from each other are only for clearly describing characteristics, and do not mean that the components are necessarily separated. That is, a plurality of components may be integrated to form a single hardware or software unit, or a single component may be distributed to form a plurality of hardware or software units. Accordingly, such integrated or distributed examples are included in the scope of the present disclosure, even though not mentioned separately.

In the present disclosure, components described in various examples may not necessarily mean essential components, and some may be optional components. Therefore, an example composed of a subset of components described in an example is also included in the scope of the present disclosure. Moreover, an example in which another component is additionally included in components described in the various examples is also included in the scope of the present disclosure.

In the present disclosure, expressions of positional relationships used herein, such as upper, lower, left, and right are described for convenience of description. If viewing the drawings shown in this specification in reverse, the positional relationship described in the specification may be interpreted in the opposite manner.

In the disclosure, the expressions “A or B”, “at least one of A and B”, “at least one of A or B”, “A, B, or C”, “at least one of A, B, and C”, and “at least one of A, B, or C” may include any and all combinations of one or more of the associated listed items.

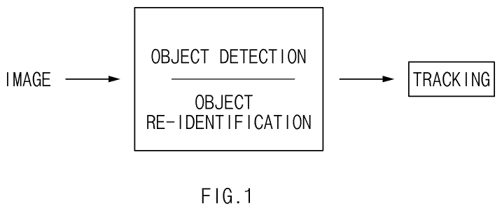

Hereinafter, various examples of the present disclosure may be described in detail with reference to FIGS. 1 to 10.

FIG. 1 shows an example of a diagram showing a tracking method, according to an example of the present disclosure.

Tracking may be performed by performing object detection and extracting visual features of an object through object re-identification. The object detection may mean creating detection information including the location of the object, bounding box information about the object, heading angle of the object, or the like. For example, the object re-identification may mean creating a feature vector for the visual features of an object, such as the size of the object, the color of the object, and/or the shape of the object. If the object re-identification is performed after the object detection is performed, a network performing object detection and a network performing object re-identification may be present separately. The presence of two networks may result in slower tracking algorithms compared to the case that object detection and object re-identification are performed by using a single network.

Referring to FIG. 1, the tracking method according to an example of the present disclosure may simultaneously perform object detection and object re-identification. For example, the tracking method may perform the object detection and the object re-identification simultaneously with one network. For example, a first neck for object detection and a second neck for object re-identification may operate as one network by sharing a backbone. The tracking method may speed up the performance of the tracking algorithm by using a model including necks sharing a backbone. Detailed descriptions regarding the tracking algorithm may be given herein.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver if the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

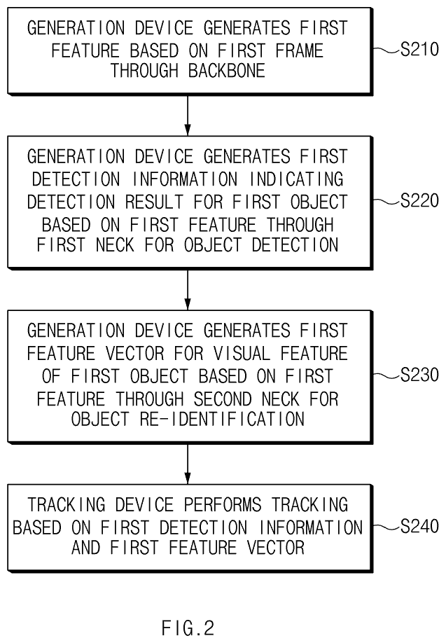

FIG. 2 shows an example of a flowchart showing a tracking method, according to an example of the present disclosure.

A detection model (e.g., a neural network) may include a backbone, at least one neck, and/or a head. The backbone may exploit the essential features of different resolutions, and the neck may fuse the features of different resolutions. At least one head may perform the detection of objects in different resolutions.”

A backbone network may be used in the object detection model architectures. Backbone may be responsible for extracting and encoding features from the input data. It may act as the core feature extractor, capturing low-level and high-level features from the input data.

A neck may be responsible for further transforming and refining the features extracted by the backbone model. The neck may improve the backbone's extracted features, and give more informative feature representations.

The backbone may be responsible for the initial feature extraction from the input data, while the neck enhances and merge those features to improve the model's performance.

The head may include task-specific layers that are designed to produce the final prediction or inference based on the information extracted by the Backbone and Neck.

In machine learning, a loss function (also known as a cost function or error function) is a method of evaluating how well a specific algorithm models the given data. By comparing the predicted values generated by the model to the actual target values, the loss function quantifies the error or difference. The purpose of the loss function is to guide the training process. When the model makes a prediction, the loss function computes a numerical value representing how far the prediction is from the true value. The goal of the learning algorithm is to minimize this loss value by adjusting the model's parameters during the training phase.

Referring to FIG. 2, according to a tracking method according to the example of the present disclosure, in S210, a generation device may generate a first feature, for example, based on a first frame through a backbone. The output of the backbone receiving an image may be referred to as a “feature”.

According to the tracking method, in S220, the generation device may generate first detection information indicating the detection result for a first object based on a first feature through a first neck for object detection. The first detection information may include location information of the first object, a heading angle of the first object, and/or bounding box information about the first object.

According to the tracking method, in S230, the generation device may generate a first feature vector for the visual feature of the first object based on the first feature through a second neck for object re-identification. For example, the first feature vector may be a vector including information about the characteristics of the first object, such as the shape of the first object, the size of the first object, and/or the color of the first object.

According to the tracking method, in S240, a tracking device may perform tracking based on the first detection information and/or the first feature vector. For example, the tracking method may perform tracking by performing association based on object detection information about the previous frame of a first frame, a feature vector of the first frame, first detection information of the first frame, and/or first detection information of the first frame. For example, the tracking method may perform tracking by performing association based on object detection information about a second frame, which may be the next frame of the first frame, a feature vector of the second frame, the first detection information of the first frame, and/or the first detection information of the first frame. Detailed descriptions regarding tracking may be given later.

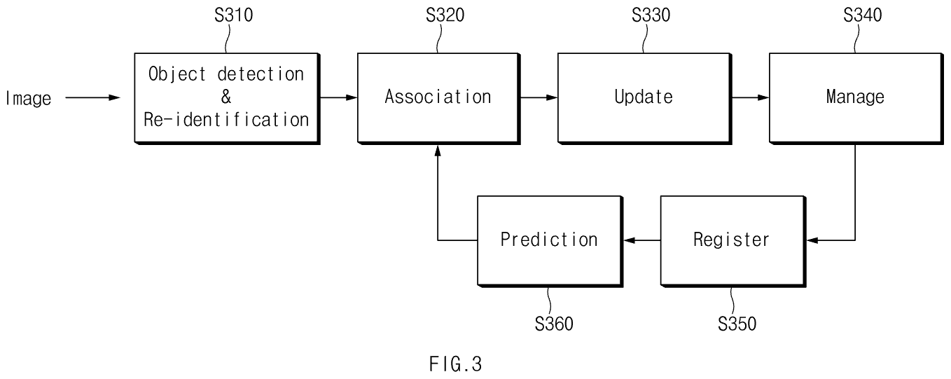

FIG. 3 shows an example of a diagram showing a tracking method, according to an example of the present disclosure.

Referring to FIG. 3, in S310, a tracking method according to an example of the present disclosure may perform object detection and/or object re-identification. The tracking method may simultaneously perform the object detection and the object re-identification with one network. For example, as described above, a first neck for object detection and a second neck for object re-identification may share a backbone. For example, the object detection and the object re-identification may be performed simultaneously.

In S320, the tracking method may perform association. The association may refer to a process of connecting an object detected in a current frame to an object detected in a previous frame. For example, an association vector for the object of the previous frame may be created by combining object detection information and a feature vector for the object detected in the previous frame. Association vectors may be created by combining pieces of object detection information and feature vectors for objects detected in the current frame. For example, the tracking method may perform association by calculating a distance between the association vector for the previous frame and the association vectors for the current frame, and/or considering an object with an association vector of the current frame, which may be closest to the association vector for the previous frame, as an object the same as the object of the previous frame. A cosine distance, a Euclidean distance, a Mahalanobis distance, and/or an intersection-over-union (IOU) may be used to calculate the distance between association vectors.

In S330, the tracking method may perform an update. For example, the tracking method may update states of objects based on the association result. For example, the tracking method may update data regarding an object, which may be placed at a first location in the previous frame, so as to be changed to data regarding an object placed at the second location in the current frame, but is not limited thereto.

In S340, the tracking method may perform management. For example, the tracking method may manage the tracking state of an object. For example, the tracking method may remove an object, whose tracking may be interrupted as the object disappears within an object detection range, from a tracking target.

In S350, the tracking method may perform registration. For example, as a new object is detected within the object detection range, the tracking method may register the new object as the tracking target.

In S360, the tracking method may perform prediction. For example, the tracking method may predict locations of objects in the next frame. For example, the tracking method may predict the locations of objects, for example, by using a Kalman filter, but is not limited thereto. Location information of predicted objects may be used in the association process. For example, the association may be performed by calculating a distance between the association vectors of objects detected as being within a predetermined distance from locations of the predicted objects and the association vectors of objects on which prediction was performed.

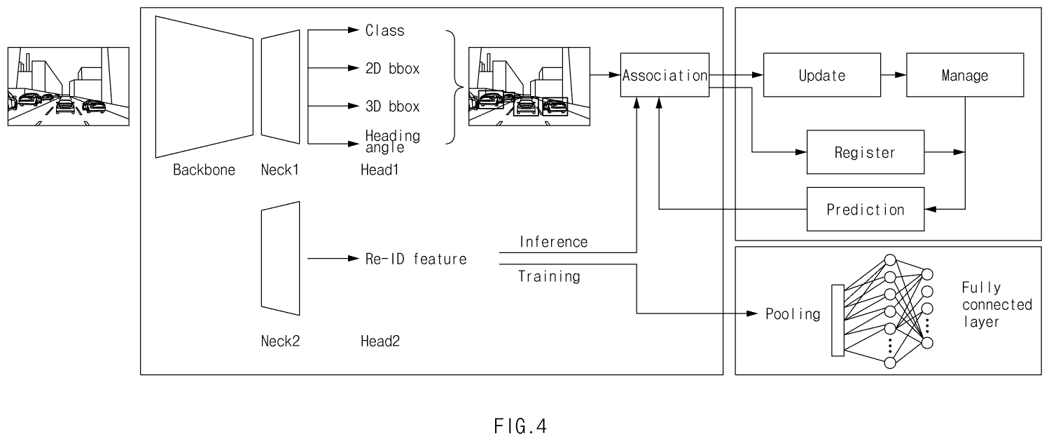

FIG. 4 shows an example of a diagram showing a tracking method, according to an example of the present disclosure.

Referring to FIG. 4, a tracking method according to an example of the present disclosure may perform an inference operation and/or a training operation. The tracking method may simultaneously perform object detection and object re-identification during the inference operation. For example, the object detection and the object re-identification may be simultaneously performed by sharing a backbone between a first neck (neck1) associated with the object detection and a second neck (neck2) associated with the object re-identification. As described herein, the tracking method may generate a first feature based on a first frame through the backbone. For example, the tracking method may generate first detection information indicating the detection result for a first object based on a first feature through the first neck. For example, the first detection information may include pieces of information about a class of an object, a 2D bounding box for the object, a 3D bounding box for the object, and/or a heading angle of the object. For example, the tracking method may generate a first feature vector for a visual feature of the first object based on the first feature through the second neck. The generated first detection information and the generated first feature vector may be used if association is performed.

The tracking method may perform the training operation. For example, the tracking method may train the backbone and the first neck based on a ground truth (GT) for the object detection. Moreover, the tracking method may train the second neck by applying a knowledge distillation technique. For example, the second neck may be trained by using the output of a first model pre-trained on the object re-identification. For example, a classification vector may be created by inputting the feature vector, which may be generated through the second neck, into a pooling layer and a fully connected layer, which may be a classification network. The second neck may be trained by comparing the GT for the object re-identification with the classification vector. Detailed descriptions regarding an operation for training the second neck may be given herein.

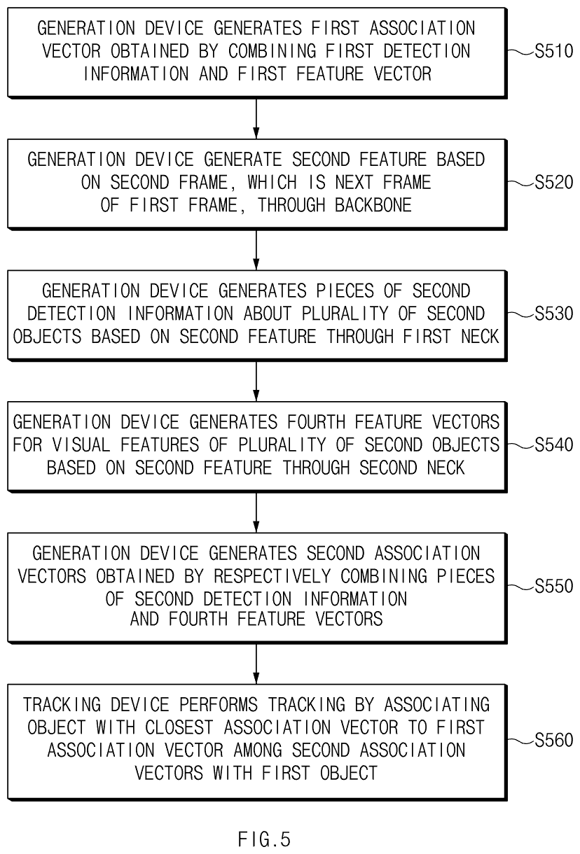

FIG. 5 shows an example of a flowchart showing a tracking method, according to an example of the present disclosure.

Referring to FIG. 5, according to a tracking method according to an example of the present disclosure, in S510 a generation device may generate a first association vector obtained by combining first detection information and a first feature vector. For example, the first association vector with 130 channels may be created, for example, by adding the first detection information about a first object to the first feature vector consisting of 128 channels, but is not limited thereto.

According to the tracking method, in S520, the generation device may generate a second feature based on a second frame, which may be the next frame of a first frame, through a backbone.

According to the tracking method, in S530, the generation device may generate pieces of second detection information about a plurality of second objects based on the second feature through a first neck.

According to the tracking method, in S540, the generation device may generate fourth feature vectors for the visual features of a plurality of second objects based on the second feature through a second neck.

According to the tracking method, in S550, the generation device may generate second association vectors obtained by respectively combining the pieces of second detection information and the fourth feature vectors.

According to the tracking method, in S560, a tracking device may perform tracking by associating an object with the closest association vector to the first association vector among the second association vectors with the first object. For example, an object corresponding to a vector, which may be closest to the first association vector in the first frame, from among the second association vectors in the second frame may correspond to the first object. For example, the tracking may be performed by associating the first object in the first frame with an object with the association vector closest to the first association vector.

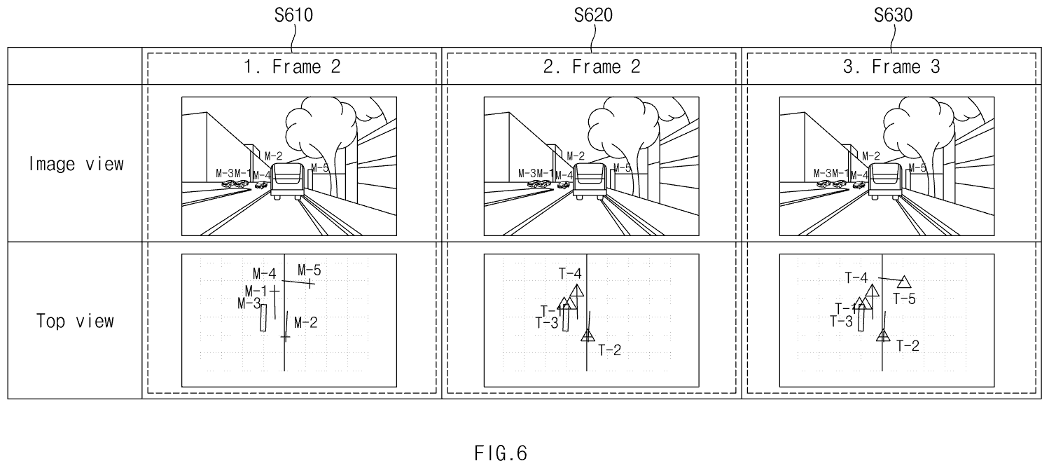

FIG. 6 shows an example of a diagram showing a tracking method, according to an example of the present disclosure.

Referring to FIG. 6, a tracking method according to an example of the present disclosure may generate pieces of detection information for objects in a first frame and feature vectors for the objects. The tracking method may predict locations of objects M-1 to M-5 in a second frame (frame 2), which may be the next frame of the first frame, based on pieces of information generated regarding the first frame (S610). The tracking method may predict the locations of objects based on the first frame. For example, if the locations of objects in the actual second frame are detected, the tracking method may perform association based on the predicted location and the actual detected location.

Association may refer to the process of identifying whether a detected object in a new frame corresponds to an object being tracked. If new detection results are received in a frame, association may comprise finding the matching object between the tracked objects and the detection results. If an object is associated, the newly received detection information, for example, such as updated location data, may be used to update the object's status. This continuous association of object recognition results over time may allow for accurate estimation of information, for example, such as location and/or velocity.

For example, if a first object in the first frame is predicted to be at a first location in the second frame, a distance between association vectors of objects, which may be away from the first location by a predetermined distance, from among objects detected in the second frame, and the association vector of the first object may be calculated. The tracking method may determine that the object with the association vector at the closest distance to the association vector of the first object is the same object as the first object, and may perform tracking T-1 to T-5 (S620). For example, the tracking method may predict the locations of objects in a third frame (frame 3), which may be the next frame of the second frame, based on pieces of information generated regarding the second frame (S630). Tracking for the second frame and the third frame may be performed by using the tracking method for the first frame and the second frame.

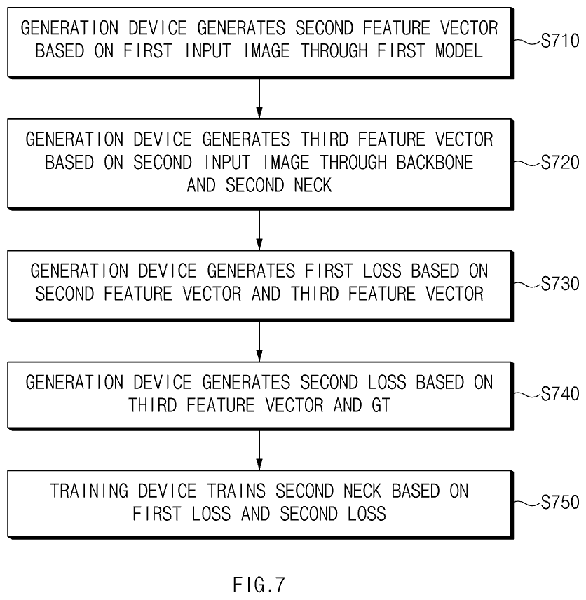

FIG. 7 shows an example of a flowchart showing a tracking method, according to an example of the present disclosure.

A tracking method according to an example of the present disclosure may train a second model including a backbone, a first neck, and a second neck based on a first model pre-trained on object re-identification. The first neck may be associated with object detection. The second neck may be associated with the object re-identification. The first neck and the second neck may share the backbone.

The tracking method may train the second model based on the first model by applying a knowledge distillation technique. For example, the tracking method may train the second neck by using the first model in a state where parameters of the backbone and the first neck are fixed. For example, the tracking method may train the second neck, for example, after freezing the backbone and the first neck. For example, referring to FIG. 7, according to the tracking method, in S710, a generation device may generate a second feature vector based on a first input image through a first model.

According to the tracking method, in S720, the generation device may generate a third feature vector based on the second input image through the backbone and the second neck. The first input image described herein may be an image obtained by extracting an object area from the second input image.

According to the tracking method, in S730, the generation device may generate a first loss based on the second feature vector and the third feature vector. For example, the tracking method may train the second neck such that the third feature vector may be close to the second feature vector, which may be the output of the first model pre-trained on the object re-identification. The tracking method may generate the first loss by comparing the second feature vector and the third feature vector. The second feature vector may include soft labeled data. Furthermore, the third feature vector may also include soft labeled data. The soft labeling may be labeling that assigns a probability or a confidence score to each of several classes, rather than a single labeling (hard labeling) for data. For example, it may be assumed that dogs, cats, and TVs need to be classified. If an output of [0.1, 1, 0.8] for a cat input is generated through a network, there may be a method for training a network such that an output of [0, 1, 0] for hard-labeled data is generated, and a method for training a network such that an output of [0.1, 1, 0.8] for soft-labeled data is generated.

According to the tracking method, in S740, the generation device may generate a second loss based on the third feature vector and GT. For example, the tracking method may generate a classification vector by inputting the third feature vector into a classification network and may generate the second loss by comparing the classification vector and the GT. For example, the GT may include hard labeled data. For example, the classification network may include a pooling layer and a fully connected layer.

At least some networks (e.g., neural networks, deep learning networks, etc.) may exploit domain-invariant features of the source and target domains with some label-induced losses that need ground-truth labels as inputs. As target ground-truth labels are unavailable, target-predicted labels that could be expressed in different forms may be used to formulate the label-induced losses.

Hard labeled data (e.g., the form of a hard label) may classify a sample into one or more definite categories, but it may be overconfident when the quality of predicted labels is poor. Soft labeled data (e.g., the form of a soft label) may provide probability values to each category for a sample, which could mitigate the overconfident problem.

According to the tracking method, in S750, a training device may train the second neck based on the first loss and the second loss. For example, the tracking method may train the second neck by using the first loss and the second loss as the total loss for the object re-identification.

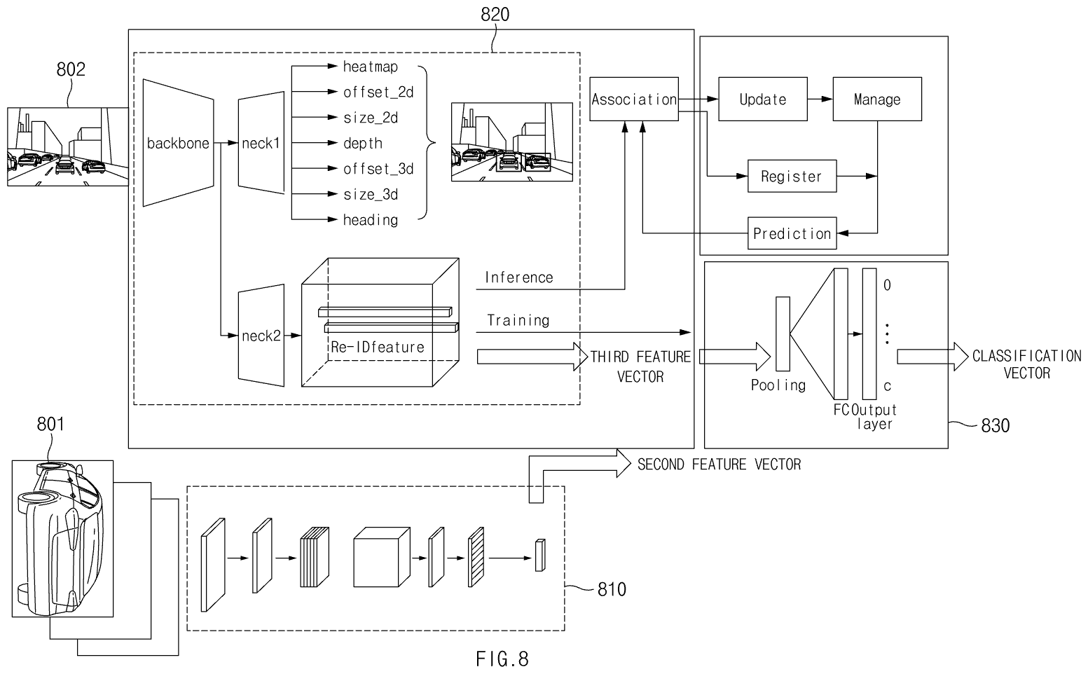

FIG. 8 shows an example of a diagram showing a tracking method, according to an example of the present disclosure.

Referring to FIG. 8, a tracking method according to an example of the present disclosure may train a second model 820 by using a first model 810. For example, the tracking method may train the second model 820 by applying a knowledge distillation technique based on the first model 810 pre-trained on object re-identification. For example, the first model 810 pre-trained on the object re-identification may generate a second feature vector based on a first input image 801. For example, the second model 820 may generate a third feature vector based on a second input image through a second neck for the object re-identification. The first input image 801 may be an image obtained by extracting an object area from a second input image 802. The second feature vector and the third feature vector may include soft labeled data. The tracking method may generate a first loss by comparing the second feature vector and the third feature vector. For example, the tracking method may input the third feature vector into a classification network 830. The third feature vector input to the classification network may be output as a classification vector. The tracking method may generate a second loss based on the classification vector and GT including hard labeling data. The tracking method may train a second neck by using the first loss and the second loss as the total loss. If the second neck is trained, the backbone and the first neck may be frozen. For example, the tracking method may train the second neck in a state where parameters of the backbone and the first neck are fixed. For example, the tracking method may train the backbone and the first neck based on data labeled regarding object detection.

The tracking method may perform tracking by performing estimation through the trained second model 820. For example, the tracking method may generate a first feature based on a first frame through the backbone. For example, the tracking method may generate first detection information indicating the detection result for the first object based on the first feature through the first neck for the object detection. The first detection information may include information about a heatmap, a size of an object, a depth, a heading angle, or the like. The tracking method may generate a first feature vector for the visual feature of the first object based on the first feature through a second neck for the object re-identification. The tracking method may perform association by calculating a distance between an association vector for the previous frame of the first frame and association vectors for the first frame. For example, the tracking method may update state information of the object based on the association result, may perform management by removing an object, whose tracking may be interrupted, and may additionally register a newly detected object to a tracking list.

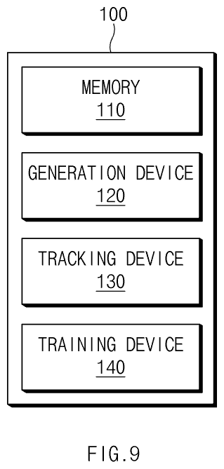

FIG. 9 shows an example of a block diagram of a tracking apparatus, according to an example of the present disclosure.

Referring to FIG. 9, a tracking apparatus 100 may include a memory 110, a generation device 120, a tracking device 130, and a training device 140. The generation device 120, the tracking device 130, and the training device 140 may correspond to a processor.

The memory 110 may be configured to store computer-executable instructions.

The processor may be configured to access the memory 110 so as to execute the instructions. For example, the processor may generate a first feature based on a first frame by using a backbone through the generation device 120. Additionally or alternatively, the processor may generate first detection information indicating the detection result for a first object based on a first feature by using a first neck for object detection through the generation device 120. Additionally or alternatively, the processor may generate a first feature vector for the visual feature of the first object based on the first feature by using a second neck for object re-identification through the generation device 120.

For example, the processor may perform tracking based on first detection information and the first feature vector through the tracking device 130.

For example, the processor may train a second model including the backbone, the first neck, and the second neck based on a first model pre-trained on the object re-identification through the training device 140. For example, the processor may train the second neck through the training device 140 in a state where parameters of the backbone and the first neck are fixed.

Additionally or alternatively, the processor may generate a second feature vector based on a first input image by using the first model through the generation device 120. For example, the processor may generate a third feature vector based on a second input image by using the backbone and the second neck through the generation device 120. The first input image may be an image obtained by extracting an object area from the second input image. The processor may generate a first loss based on the second feature vector and the third feature vector through the generation device 120. For example, the second feature vector may include soft labeled data. The processor may generate a second loss based on the third feature vector and GT through the generation device 120. For example, the processor may train the second neck based on the first loss and the second loss through the training device 140.

The processor may generate a classification vector based on the third feature vector by using a classification network through the generation device 120. Additionally or alternatively, the processor may generate the second loss by comparing the classification vector and the GT through the generation device 120. For example, the GT may include hard labeled data.

The processor may generate a first association vector, which is obtained by combining first detection information and the first feature vector, through the generation device 120. For example, the processor may generate a second feature based on a second frame, which may be the next frame of the first frame, for example, by using the backbone through the generation device 120. Additionally or alternatively, the processor may generate pieces of second detection information about a plurality of second objects based on the second feature by using the first neck through the generation device 120. For example, the processor may generate fourth feature vectors for visual features of a plurality of second objects based on the second feature by using the second neck through the generation device 120. For example, the processor may generate second association vectors, which may be obtained by respectively combining the pieces of second detection information and the fourth feature vectors, through the generation device 120.

The processor may perform tracking by associating an object with an association vector closest to a first association vector among the second association vectors with the first object, through the tracking device 130. The distance between vectors may be calculated by using a cosine distance, a Euclidean distance, or the like.

According to an aspect of the present disclosure, a tracking method may include generating, by a generation device, a first feature based on a first frame through a backbone, generating, by the generation device, first detection information indicating a detection result for a first object based on the first feature through a first neck for object detection, generating, by the generation device, a first feature vector for a visual feature of the first object based on the first feature through a second neck for object re-identification, and performing, by a tracking device, tracking based on the first detection information and the first feature vector.

According to an example, the tracking method may further include training, by a training device, a second model including the backbone, the first neck, and the second neck based on a first model pre-trained on the object re-identification.

According to an example, the training of the second model may include training, by the training device, the second neck in a state where parameters of the backbone and the first neck are fixed.

According to an example, the training of the second model may include generating, by the generation device, a second feature vector based on a first input image through the first model, generating, by the generation device, a third feature vector based on a second input image through the backbone and the second neck, generating, by the generation device, a first loss based on the second feature vector and the third feature vector, and training, by the training device, the second neck based on the first loss.

According to an example, the training of the second model may include generating, by the generation device, a second loss based on the third feature vector and ground truth (GT), and training, by the training device, the second neck based on the first loss and the second loss.

According to an example, the generating of the second loss may include generating, by the generation device, classification vector based on the third feature vector through a classification network, and generating, by the generation device, the second loss by comparing the classification vector and the GT.

According to an example, the GT may include hard labeled data.

According to an example, the second feature vector may include soft labeled data.

According to an example, the first input image may be an image obtained by extracting an object area from the second input image.

According to an example, the performing of the tracking may include generating, by the generation device, a first association vector obtained by combining the first detection information and the first feature vector, generating, by the generation device, a second feature based on a second frame, which is a next frame of the first frame, through the backbone, generating, by the generation device, pieces of second detection information about a plurality of second objects based on the second feature through the first neck, generating, by the generation device, fourth feature vectors for visual features of the plurality of second objects based on the second feature through the second neck, generating, by the generation device, second association vectors, which are obtained by respectively combining the pieces of second detection information and the fourth feature vectors, and performing, by the tracking device, tracking by associating an object with an association vector closest to the first association vector among the second association vectors with the first object.

According to an aspect of the present disclosure, a tracking apparatus may include a memory that stores computer-executable instructions and at least one processor that executes the instructions by accessing the memory. The at least one processor may be configured to generate, through a generation device, a first feature based on a first frame by using a backbone, to generate first detection information indicating a detection result for a first object based on the first feature by using a first neck for object detection, and to generate a first feature vector for a visual feature of the first object based on the first feature by using a second neck for object re-identification, and to perform, through a tracking device, tracking based on the first detection information and the first feature vector.

According to an example, the at least one processor may be configured to train, through a training device, a second model including the backbone, the first neck, and the second neck based on a first model pre-trained on the object re-identification.

For example, the at least one processor may be configured to train, through the training device, the second neck in a state where parameters of the backbone and the first neck are fixed.

For example, the at least one processor may be configured to generate, through the generation device, a second feature vector based on a first input image by using the first model, to generate a third feature vector based on a second input image by using the backbone and the second neck, and to generate a first loss based on the second feature vector and the third feature vector, and to train, through the training device, the second neck based on the first loss.

For example, the at least one processor may be configured to generate, through the generation device, a second loss based on the third feature vector and GT, and to train, through the training device, the second neck based on the first loss and the second loss.

For example, the at least one processor may be configured to generate, through the generation device, a classification vector based on the third feature vector by using a classification network, and to generate the second loss by comparing the classification vector and the GT.

For example, the GT may include hard labeled data.

For example, the second feature vector may include soft labeled data.

For example, the first input image may be an image obtained by extracting an object area from the second input image.

For example, the at least one processor may be configured to generate, through the generation device, a first association vector obtained by combining the first detection information and the first feature vector, to generate a second feature based on a second frame, which is a next frame of the first frame, by using the backbone, to generate pieces of second detection information about a plurality of second objects based on the second feature by using the first neck, to generate fourth feature vectors for visual features of the plurality of second objects based on the second feature by using the second neck, and to generate second association vectors, which are obtained by respectively combining the pieces of second detection information and the fourth feature vectors, and to perform, through the tracking device, tracking by associating an object with an association vector closest to the first association vector among the second association vectors with the first object.

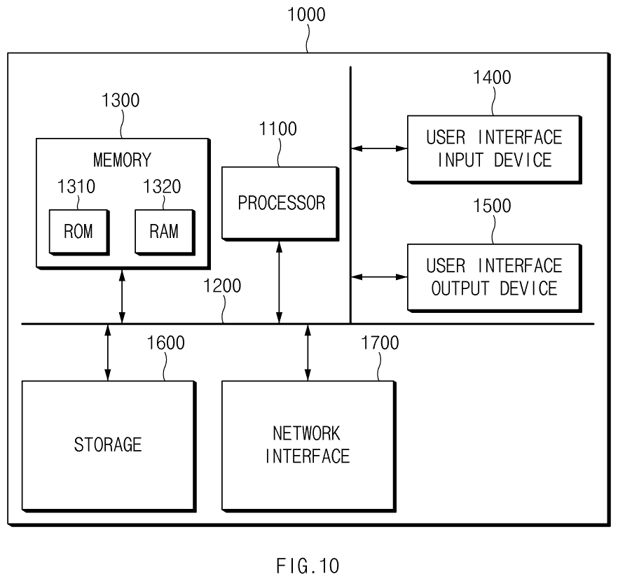

FIG. 10 shows an example of a block diagram of a computing system for executing a tracking method, according to an example of the present disclosure.

Referring to FIG. 10, a computing system 1000 may include at least one processor 1100, a memory 1300, a user interface input device 1400, a user interface output device 1500, storage 1600, and a network interface 1700, which may be connected with each other via a bus 1200.

The processor 1100 may be a central processing device (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Accordingly, the processes of the method or algorithm described in relation to the examples of the present disclosure may be implemented directly by hardware executed by the processor 1100, a software module, or a combination thereof. The software module may reside in a storage medium (that is, the memory 1300 and/or the storage 1600), such as a RAM, a flash memory, a ROM, an EPROM, an EEPROM, a register, a hard disk, solid state drive (SSD), a detachable disk, or a CD-ROM. The exemplary storage medium is coupled to the processor 1100, and the processor 1100 may read information from the storage medium and may write information in the storage medium. In another method, the storage medium may be integrated with the processor 1100. The processor 1100 and the storage medium may reside in an application specific integrated circuit (ASIC). The ASIC may reside in a user terminal. In another method, the processor 1100 and the storage medium may reside in the user terminal as an individual component.

Hereinabove, although the present disclosure has been described with reference to exemplary examples and the accompanying drawings, the present disclosure is not limited thereto, but may be variously modified and altered by those skilled in the art to which the present disclosure pertains without departing from the spirit and scope of the present disclosure claimed in the following claims.

The examples of the present disclosure may be provided to explain the spirit and scope of the present disclosure, but not to limit them, so that the spirit and scope of the present disclosure is not limited by the examples. The scope of the present disclosure may be construed on the basis of the accompanying claims, and all the technical ideas within the scope equivalent to the claims may be included in the scope of the present disclosure. The above description is merely an example of the technical idea of the present disclosure, and various modifications and modifications may be made by one skilled in the art without departing from the essential characteristic of the present disclosure. Accordingly, examples of the present disclosure are intended not to limit but to explain the technical idea of the present disclosure, and the scope and spirit of the present disclosure is not limited by the above examples. The scope of protection of the present disclosure may be construed by the attached claims, and all equivalents thereof may be construed as being included within the scope of the present disclosure.

In accordance with a tracking method according to the example of the present disclosure, it is possible to improve tracking performance without causing performance degradation in object detection.

In accordance with a tracking method according to the example of the present disclosure, it is possible to perform training on an object re-identification model by applying a knowledge distillation technique.

In accordance with a tracking method according to the example of the present disclosure, it is possible to perform training on an object re-identification model by using a pre-trained model.

In accordance with a tracking method according to the example of the present disclosure, it is possible to simultaneously perform object detection and object re-identification.

A tracking method according to the example of the present disclosure may perform multi-task learning associated with tracking.

In accordance with a tracking method according to the example of the present disclosure, a decoder detecting an object and a decoder re-identifying the object may share a backbone.

Effects obtained in the present disclosure are not limited to the above-mentioned effects, and other effects that are not mentioned will be clearly understood by those skilled in the art, to which the present disclosure belongs, from the following description.

Hereinabove, although the present disclosure was described with reference to exemplary examples and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A method performed by at least one computing device, the method comprising:
generating, based on a first frame and via a backbone of a detection model, a first feature;
generating, based on the first feature and via a first neck of the detection model, first detection information indicating a detection result for a first object, wherein the first neck is configured for object detection;
generating, based on the first feature and via a second neck of the detection model, a first feature vector for a visual feature of the first object, wherein the second neck is configured for object re-identification; and
performing, based on the first detection information and the first feature vector, tracking of at least one object comprising the first object.

2. The method of claim 1, further comprising:
training, based on a first model pre-trained on the object re-identification, a second model, wherein the second model comprises the backbone, the first neck, and the second neck.

3. The method of claim 2, wherein the training of the second model comprises:
training the second neck in a state where parameters of the backbone and the first neck are fixed.

4. The method of claim 2, wherein the training of the second model comprises:
generating, based on a first input image and via the first model, a second feature vector;
generating, based on a second input image and via the backbone and the second neck, a third feature vector;
generating, based on the second feature vector and the third feature vector, a first loss; and
training, based on the first loss, the second neck.

5. The method of claim 4, wherein the training of the second model comprises:
generating, based on the third feature vector and ground truth (GT), a second loss, and
wherein the training of the second neck comprises training, based on the first loss and the second loss, the second neck.

6. The method of claim 5, wherein the generating of the second loss comprises:
generating, based on the third feature vector and via a classification network, a classification vector; and
generating the second loss by comparing the classification vector and the GT.

7. The method of claim 5, wherein the GT comprises hard labeled data.

8. The method of claim 4, wherein the second feature vector comprises soft labeled data.

9. The method of claim 4, wherein the first input image is an image obtained by extracting an object area from the second input image.

10. The method of claim 1, wherein the performing of the tracking comprises:
generating a first association vector obtained by combining the first detection information and the first feature vector;
generating, based on a second frame and via the backbone, a second feature, wherein the second frame is a next frame of the first frame;
generating, based on the second feature and via the first neck, pieces of second detection information about a plurality of second objects;
generating, based on the second feature and via the second neck, fourth feature vectors for visual features of the plurality of second objects;
generating second association vectors, wherein the second association vectors are obtained by respectively combining the pieces of second detection information and the fourth feature vectors; and
performing the tracking by associating the first object with an object having an association vector,, among the second association vectors, that is closest to the first association vector.

11. An apparatus comprising:
a memory configured to store computer-executable instructions; and
at least one processor configured to execute the computer-executable instructions by accessing the memory,
wherein the at least one processor is configured to:
generate, based on a first frame and via a backbone of a detection model, a first feature,
generate, based on the first feature and via a first neck of the detection model, first detection information indicating a detection result for a first object, wherein the first neck is configured for object detection,
generate, based on the first feature and via a second neck of the detection model, a first feature vector for a visual feature of the first object, wherein the second neck is configured for object re-identification; and
perform, based on the first detection information and the first feature vector, tracking of at least one object comprising the first object.

12. The apparatus of claim 11, wherein the at least one processor is configured to:
train, based on a first model pre-trained on the object re-identification, a second model, wherein the second model comprises the backbone, the first neck, and the second neck.

13. The apparatus of claim 12, wherein the at least one processor is configured to:
train the second neck in a state where parameters of the backbone and the first neck are fixed.

14. The apparatus of claim 12, wherein the at least one processor is configured to:
generate, based on a first input image and via the first model, a second feature vector;
generate, based on a second input image and via the backbone and the second neck, a third feature vector;
generate, based on the second feature vector and the third feature vector, a first loss; and
train, based on the first loss, the second neck.

15. The apparatus of claim 14, wherein the at least one processor is configured to:
generate, based on the third feature vector and ground truth (GT), a second loss; and
train the second neck based on the first loss and the second loss.

16. The apparatus of claim 15, wherein the at least one processor is configured to:
generate, based on the third feature vector and via a classification network, a classification vector, and
generate the second loss by comparing the classification vector and the GT.

17. The apparatus of claim 15, wherein the GT comprises hard labeled data.

18. The apparatus of claim 14, wherein the second feature vector comprises soft labeled data.

19. The apparatus of claim 14, wherein the first input image is an image obtained by extracting an object area from the second input image.

20. The apparatus of claim 11, wherein the at least one processor is configured to:
generate a first association vector obtained by combining the first detection information and the first feature vector;
generate, based on a second frame and via the backbone, a second feature, wherein the second frame is a next frame of the first frame;
generate, based on the second feature and via the first neck, pieces of second detection information about a plurality of second objects;
generate, based on the second feature and via the second neck, fourth feature vectors for visual features of the plurality of second objects;
generate second association vectors, wherein the second association vectors are obtained by respectively combining the pieces of second detection information and the fourth feature vectors; and
perform the tracking by associating the first object with an object having an association vector, among the second association vectors, that is closest to the first association vector.
